(19) United States
(12) Patent Application Publication
(10) Pub. No.: US 2020/0143370 A1
(43) Pub. Date: May 7, 2020

(54) METHOD FOR AUTHENTICATING AND AUTHORISING A TRANSACTION USING A PORTABLE DEVICE

(71) Applicant: Bluechain Pty Ltd, Hawthorn (AU)

(72) Inventors: Craig GLENDENNING, Hawthorn (AU); Michael MCAULEY, Hawthorn (AU)

(21) Appl. No.: 15/764,795

(22) PCT Filed: Sep. 29, 2016
(86) PCT No.: PCT/AU2016/050919

§ 371 Date: May 23, 2018

(30) Foreign Application Priority Data
Sep. 30, 2015 (AU) 2015903975

(51) Int. Cl. G06Q 20/38; H04L 9/32; H04W 12/06; G06Q 20/32; G06Q 20/40; G06Q 20/42; G06Q 40/02; H04W 8/18

(52) U.S. Cl. CPC G06Q 20/3829; H04L 9/3234; H04L 9/3263; H04W 12/0609; G06Q 20/3226; G06Q 2220/00; G06Q 20/401; G06Q 20/42; G06Q 40/02; H04W 8/18; H04L 2209/56; G06Q 20/38215

(57) ABSTRACT

A method is provided which comprises receiving at a server system associated with a card issuer or card program manager a transaction request for a transaction, the transaction request containing data to identify a customer account number; determining a mobile computing device associated with the customer account number; transmitting to the mobile computing device a payment request, the payment request comprising: (i) a requesting entity certificate signed with a private key of the card issuer or card program manager, and (ii) transaction data specifying the transaction and signed with the private key defined in (i); and receiving from the mobile computing device a payment authorisation message to authorise the transaction, the payment authorisation message comprising a cryptogram based on (i) data contained in the requesting entity certificate, (ii) data contained in a payment entity certificate, (iii) transaction data and (iv) mobile computing device data, where the cryptogram is signed with a cryptographic key stored on the mobile computing device. A server system associated with a card issuer or card program manager is further provided.

### TECHNICAL FIELD

Described embodiments relate generally to methods and systems for facilitating secure authorisation of electronic transactions.

### BACKGROUND

In today's payment environment, when a customer wants to make a not present payment to a merchant (for example making a payment over the internet), there are limited options available. The most common methodology to effect payment is for the customer to enter manually or electronically the Permanent Account Number (PAN) of an existing card scheme (for example Visa, MasterCard and American Express) into a device or an internet payment page. When the PAN is entered into a payment page, a payment transaction (the transaction amount, the PAN and other associated information) is formed and the payment transaction is routed to an Acquirer's host system over a suitable communications pathway (such as the Internet or wireless GPRS/4G). The Acquirer's host system will then interrogate the PAN and determine which card scheme the payment transaction should be routed to and proceeds to route the transaction to the card scheme switch. Once the card scheme switch has determined the issuer, it will forward the payment transaction to the appropriate Card Issuer/Card Program Manager System (CPMS) for authorisation processing.

The Card Issuer (or CPMS) may approve the transaction immediately, or the Card Issuer may produce a confirmation request (an authorisation code) which is passed to the customer's mobile device using SMS. Alternatively, the confirmation request may be received by the customer having a separate 2nd factor device which generates a one-time code based on time intervals. The generated one-time code at the appropriate point in time is then entered into an online payment page and sent to the Acquirer's host system. The Acquirer's host system identifies the Card Issuer from the code and forwards the code to the Card Issuer for verification. The Card Issuer is able to verify that the code sent via SMS or obtained from a 2^{nd} factor device is valid and based on this valid code, authorise the transaction. The Card Issuer ultimately draws settlement funds from the customer's bank account to pay for the transaction. The Card Issuer will then settle those funds with the relevant card scheme, and the card scheme will settle funds with the Acquirer host system. The Acquirer host system will then settle funds with the merchant to complete the transaction cycle.

These processes and 2^{nd} factor devices do not provide an irrefutable method of authenticating and securing transactions from man-in-the-middle attacks. The processes are susceptible to man-in-the-middle attacks as the codes entered have no relationship to the transaction data they are authorising, the intended recipient and the amount could have been altered to that which they are authorising.

### SUMMARY

A method is provided which comprises:
receiving at a server system associated with a card issuer or card program manager a transaction request for a transaction, the transaction request containing data to identify a customer account number;
determining a mobile computing device associated with the customer account number;
transmitting to the mobile computing device a payment request, the payment request comprising: (i) a requesting entity certificate signed with a private key of the card issuer or card program manager, and (ii) transaction data specifying the transaction and signed with the private key defined in (i); and
receiving from the mobile computing device a payment authorisation message to authorise the transaction, the payment authorisation message comprising a cryptogram based on (i) data contained in the requesting entity certificate, (ii) data contained in a payment entity certificate, (iii) transaction data and (iv) mobile computing device data, the cryptogram signed with a cryptographic key stored on the mobile computing device.

It should be appreciated that a mobile computing device encompasses in some embodiments a single mobile computing device and in other embodiments a plurality of mobile computing devices associated with the customer account number. Accordingly the step of determining a mobile computing device associated with the customer account number includes within its breadth determining a plurality of mobile computing devices associated with the customer account number.

In some embodiments, the transaction request is received from a client computing device via a merchant server.

In some embodiments, the client computing device is different from the mobile computing device.

In some embodiments, transmitting a payment request to the mobile computing device comprises (1) transmitting a first data packet comprising the requesting entity certificate signed with a private key of the card issuer or card program manager; and (2) separately transmitting a second data packet comprising the transaction data specifying the transaction and signed with the private key of the card issuer or card program manager.

In some embodiments the cryptographic key is a symmetric key and the server system has access to a decryption key to decrypt the cryptogram and thereby determine whether the transaction has been authorised by the mobile computing device.

In some embodiments upon receiving the payment authorisation message to authorise the transaction, the method further comprises forwarding the transaction request to a financial institution managing a customer account associated with the customer account number.

In some embodiments, the method may further comprise generating a customer profile associated with the customer account number. In some embodiments the method may further comprise generating a plurality of virtual payment cards each of which is linked to the customer profile, wherein each virtual payment card is associated with a different customer account. Each virtual payment card is preferably linked to a unique mobile computing device.

The data contained in the requesting entity certificate preferably comprises at least a requesting entity identifier and account details from the requesting entity certificate, the data contained in the payment entity certificate preferably comprises a payment entity identifier and account details from the payment entity certificate, and the transaction data preferably comprises at least the transaction amount. Data contained the mobile computing device preferably comprise an identifier of an application bound to the mobile computing device.

The account details from the payment entity certificate are preferably associated with a selected virtual payment card, and wherein the selected virtual payment card is received from a user of the mobile computing device.

In some embodiments the method may further comprise forwarding the transaction request to a financial institution managing a customer account associated with the customer selected virtual payment card.

In some embodiments the method may further comprise transmitting an authorisation notification to the merchant server in response to determining that the transaction request has been authorised.

A server system associated with a card issuer or card program manager is provided, the server system comprising:
a memory;
a processor coupled to the memory and configured to:
receive a transaction request for a transaction, the transaction request containing data to identify a customer account number;
determine a mobile computing device associated with the customer account number;
transmit to the mobile computing device a payment request, the payment request comprising: (i) a requesting entity certificate signed with a private key of the card issuer or card program manager, and (ii) transaction data specifying the transaction and signed with the private key defined in (i); and
receive from the mobile computing device a payment authorisation message to authorise the transaction, the payment authorisation message comprising a cryptogram based on (i) data contained in the requesting entity certificate, (ii) data contained in a payment entity certificate, (iii) transaction data and (iv) mobile computing device data, the cryptogram signed with a cryptographic key stored on the mobile computing device.

In some embodiments of the server system, the cryptographic key is a symmetric key and the server system has access to a decryption key to decrypt the cryptogram and thereby determine whether the transaction has been authorised by the mobile computing device.

In some embodiments of the server system, the processor is further configured to generate a customer profile associated with the customer account number. In some embodiments the processor may be further configured to generate a plurality of virtual payment cards each of which is linked to the customer profile, wherein each virtual payment card is associated with a different customer account.

Preferably, the data contained in the requesting entity certificate comprises at least a requesting entity identifier and account details from the requesting entity certificate, the data contained in the payment entity certificate comprises a payment entity identifier and account details from the payment entity certificate, and the transaction data comprises at least the transaction amount.

In some embodiments, account details from the payment entity certificate are associated with a selected virtual payment card, and the processor is further configured to receive from a user of the mobile computing device data indicative of the selected virtual payment card. The processor may be further configured to forward the transaction request to a financial institution managing a customer account associated with the customer selected virtual payment card. In some embodiments, the processor may be further configured to transmit an authorisation notification to the merchant server in response to determining that the transaction request has been authorised.

Further provided is computer-readable storage storing executable program instructions which, when executed by at least one computer processor, cause the at least one computer processor to perform the method as described above in at least one of its embodiments.

### BRIEF DESCRIPTION OF DRAWINGS

Embodiments are explained in further detail below, by way of example and with reference to the accompanying drawings, in which:

FIG. 1 is a schematic representation of a system context in which described embodiments may facilitate secure transaction authorisation;

FIG. 2 is a more detailed schematic representation of the system context shown in FIG. 1; and

FIG. 3 is a flowchart of a method of facilitating a secure transaction authentication for a registered or an unregistered merchant.

### DETAILED DESCRIPTION

The proposed method provides a process, in conjunction with patent WO2011/088508, for securing and providing irrefutable authentication of a transaction initiated in an unsecure environment. The contents of WO2011/088508 are hereby incorporated herein in their entirety.

Various units, circuits, or other components may be described herein as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C (112), paragraph six, interpretation for that unit/circuit/component.

The term “mobile computing device” is used herein to refer to any form of mobile computing and communication device that may be carried by a person, such as a smartphone, tablet computer, smartwatch, laptop computer and the like that include communication circuitry and a processor configured to perform the operations of the various embodiments.

Embodiments of the present invention allow for securing not present transactions in both the traditional payment environment and an innovative payment environment, hereinafter referred to as the Bluechain™ environment. It should be appreciated that the Bluechain™ environment is in effect a Server System, otherwise referred to as a Payment Server which resides in a Payment Card Industry—a data security standard (PCI-DSS) compliant environment. The Payment Server will include one or more processors (for example microprocessors), memory (for example RAM, Flash memory), software, network connection devices and persistent memory storage used for database purposes. Reference to the Payment Server throughout this specification is a direct reference to the Bluechain™ environment.

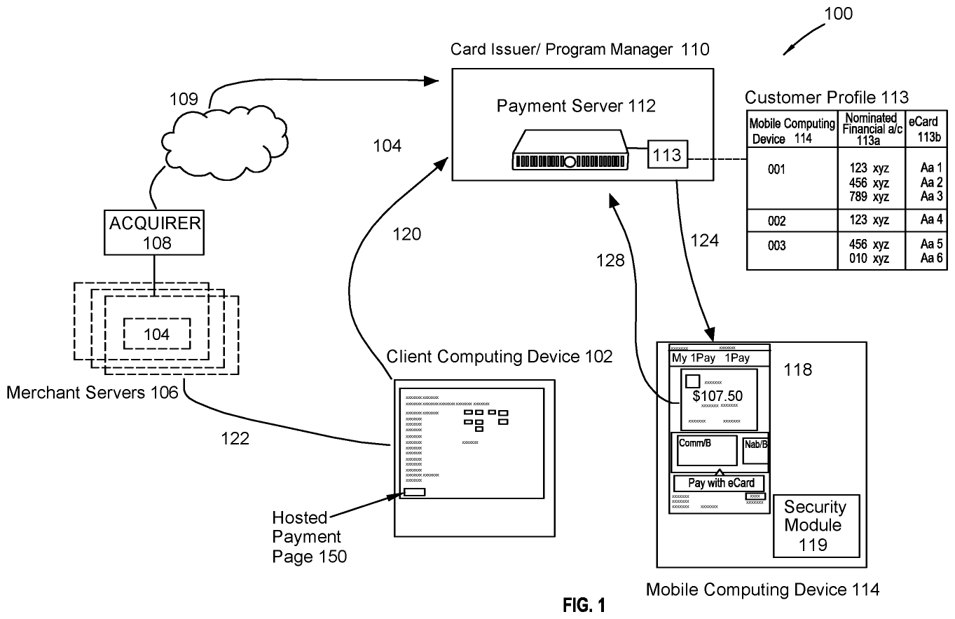

FIG. 1 illustrates an electronic transaction environment 100 which incorporates the Payment Server 112. The environment 100 comprises computer hardware and software and communications infrastructure (including the Internet and data and telephony communications), specifically including computer servers, server systems, mobile computing devices and client computing devices, not of which all are illustrated.

Generally speaking, in a transaction scenario, environment 100 comprises a client computing device 102 that may initiate an electronic transaction in cooperation with a merchant server 104. The merchant server 104 may be one of a number of merchant servers 106 with varying functions to interface with a number of customer computing devices to facilitate electronic payment transactions. The merchant servers 106 are in communication with an Acquirer 108 and a Card Scheme switch 109 which are in communication with Card Issuer (e.g. credit card) or a Card Program Manager 110 which is associated with a Payment Server 112. A Card Program Manager is an entity who manages a card interface on behalf of a third party. The Payment Server 112 is able to communicate with mobile computing devices 114 (of which one is illustrated) each of which is associated with a customer account PAN which would be specified in the transaction initiated at the client computing device 102.

### Registration Process

Prospective customers to the Bluechain™ environment are required to download a Bluechain™ payment application 118 to their mobile computing device 114. The downloaded payment application 118 will initially be bound to the specific mobile computing device 114, which will also be bound to a customer's profile. The customer can link many devices to a single profile. Should a customer wish to register multiple mobile computing devices, an application is required to be downloaded to each mobile computing device. The customer will then be prompted to complete a profile registration process where the customer is required to register their personal details in order to create a customer profile. The personal details provided will be verified against different government and private databases (e.g. passport, drivers license, telecommunications) to ensure that the individual exists. Once the customer's identity has been identified and a customer profile 113 created the customer will be prompted to nominate one or multiple financial accounts 113a. For each financial account nominated, the Payment Server 112 will in response generate a unique registration code. The customer will be required to retrieve the respective registration codes and enter the or each code into a relevant field of the downloaded application 118 to show they have access to the nominated financial accounts. This in effect registers each nominated financial accounts.

In response, the payment server 112 will generate a payment specific virtual card, referred hereinafter as an eCard 113b, for each nominated financial account associated with a specific mobile device. According, if a customer registers two mobile computing devices, where the first mobile computing device has a first account from financial institution A, a second account from financial institution A and an account from financial institution B and the second mobile computing device has the same first account from financial institution A and the same account from financial institution B, then the payment server 112 will generate five unique eCards. Each eCard is bound/linked to (i) the customer's profile and (ii) the specific mobile computing device 114 which was used to add the nominated financial account. Data associating the customer profile with the registered nominated account/s and the mobile computing device/s 114 will be stored within the Payment Server 112. By having eCards being unique to a specific mobile computing device, one is able to have the same account present on multiple devices. Moreover if a device is lost, Bluechain™ is able to cancel the associated eCard, without effecting the other devices. Furthermore, in the event of a dispute between two parties, Bluechain™ is able to identify which mobile computing device was used.

Next, a query is generated such that the customer is asked if they would like to generate a GlobalCard which if generated will be associated with the customers profile 113. The benefit of the GlobalCard is that it provides a link between the traditional payment environment and the customer's profile within the Bluechain™ environment. When generating a GlobalCard, the GlobalCard PAN will be linked to a customer detail such as a phone number, email account or similar information which may be used to identify the customer. The GlobalCard may be a scheme based PAN issued and managed by a Card Issuer/Card Program Manager 110 who has a direct connection with the Payment Server 112.

When a paying entity (for instance a customer) wants to make a not present payment to a merchant (for instance over the internet), they will be presented with different options on the merchant's payment webpage 150, depending on whether they are dealing with a merchant who has registered with Bluechain™ or one who remains unregistered. If the merchant is a registered merchant, then from the payment options on the hosted payment page 150 the customer will be able to select from a variety of options, the Bluechain™ payment option. If the merchant is an unregistered merchant then the Bluechain™ payment option will not appear, however the customer will be able to simply select the credit card option (for instance VISA™/Mastercard™) and, rather than entering the specific credit card PAN, the customer can enter their GlobalCard PAN and the required customer detail. If the customer is using their registered mobile computing device 114 to make the purchase, the GlobalCard PAN and customer detail will automatically populate the relevant fields.

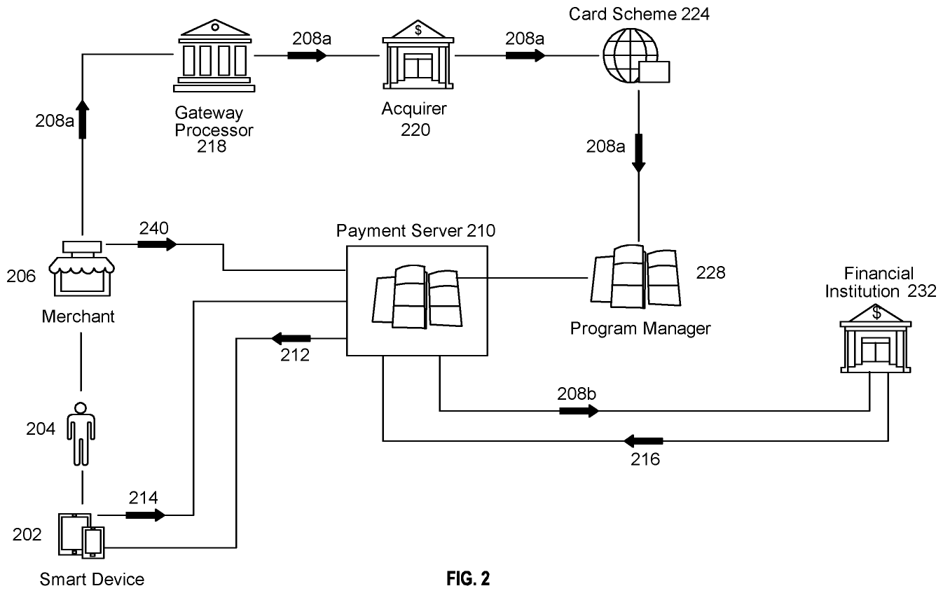

When the GlobalCard PAN and customer detail is entered into the hosted payment page 150 or transmitted via a wireless connection, a Bluechain™ compliant transaction request is generated by the Payment Server 112. For instances where the merchant is a registered merchant (as will be described in detail below with reference to FIG. 2), the transaction request is directly routed 120 to the Payment Server 112. For instances where the merchant is an unregistered merchant (as will be described in detail below), the transaction request is routed 122 via the merchant server 104, Acquirer 108, Card Scheme switch 109, card issuer/card program manager 110 and to the Payment Server 112 for processing.

The Payment Server 112 identifies the mobile computing device(s) associated with the GlobalCard used in the Bluechain™ compliant transaction request. The Payment Server 112 generates a Payment Request on behalf of the requesting entity (i.e the merchant). The Payment Request is then sent 124 directly to the mobile computing device 114, or to each mobile computing device if more than one mobile computing device is registered for the customer and associated with the GlobalCard. For ease of reference, only one mobile computing device will be referred to as is illustrated in FIG. 1, though it is to be appreciated that there can be a plurality of devices.

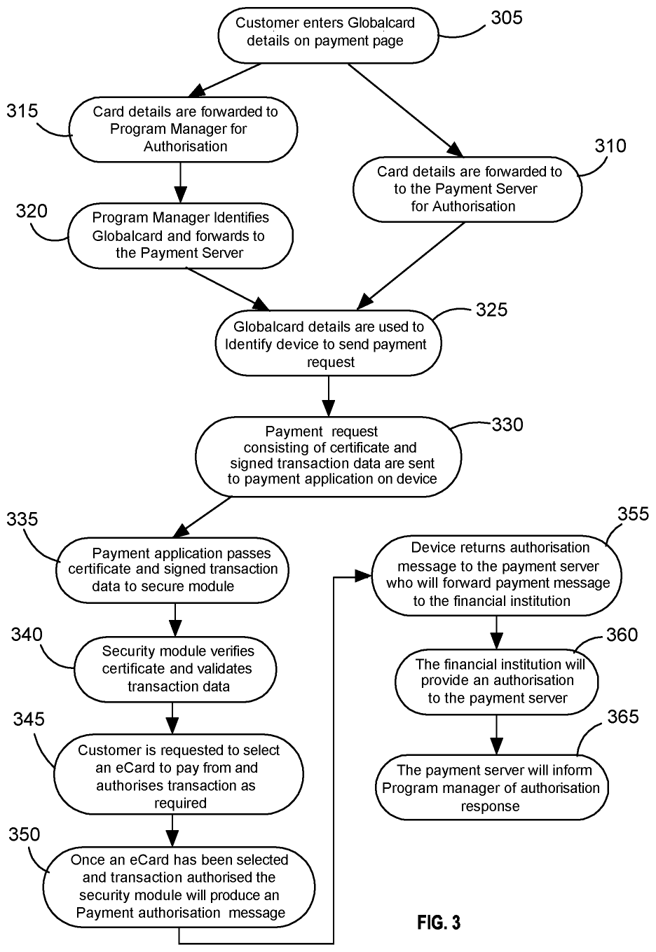

Once the Payment Request reaches the nominated mobile computing device, attributes of the Payment Request (a signed certificate and signed transaction data specifying the transaction) are passed to the mobile computing device's security module 119 and authentication of the certificate and transaction data will follow the process shown in FIG. 3. The security module 119 verifies the certificate from a public key known to or accessible to the device itself and the mobile computing device's security module 119 will use the public key of the verified certificate to validate the transaction.

Once the requestor's (merchant) details has been verified and the transaction detail validated, the customer is then prompted to select which eCard they wish to use to make the payment and upon selection of an eCard the customer is prompted to authorise the transaction. Once the customer has authorised the transaction a Payment Authorisation Message is generated and returned 128 to the Payment Server 112 for verification and authorisation.

There are three methods for making a not present payment. The first being that which is defined and documented in patent WO2011/088508. This method is referred to as “in application payment transaction” and will not be defined further in this application. The second and third methods refer to transactions where the merchants are respectively unregistered and registered. Both methods are described with reference to FIG. 2. It should be appreciated that there is certain overlap with the method already described in relation to FIG. 1.

### Unregistered Entities/Merchants

Unregistered entities (such an entity may be a merchant) are those that have not yet registered with the Bluechain™ environment. At the time of a transaction, the payment will be conducted as a traditional card scheme based payment and are therefore processed through a card scheme 3rd party switch or Card Scheme 224 (e.g. Visa, MasterCard) by the acquiring entity before being delivered to the Issuing entity, be that a financial institution or a Card Program Manager who is managing the card processing on behalf of a 3^{rd} party or financial organisation. The entity managing the card is directly associated with the Payment Server 210.

A customer 204 performing a transaction with an unregistered merchant enters their GlobalCard PAN and customer detail into a payment page managed by a merchant device 206 (otherwise referred to as a requesting entity device). The merchant device 206 prepares and forwards a Transaction Request 208a via a gateway processor 218, and to the merchant's acquiring entity (i.e. a transaction acquirer) 220. As the GlobalCard PAN is not controlled by the merchant's acquiring entity 220, the Transaction Request will be forwarded to the Card Scheme switch 224. The Card Scheme switch 224 will be able to identify (from the GlobalCard PAN details specified in the Transaction Request 208a via the payment page on the client computing device) which Card Issuer or Card Program Manager is managing the GlobalCard and the Card Scheme switch 224 will forward the transaction request to that Card Issuer/Card Program Manager 228 for processing. The GlobalCard PAN used will be known to the Card Issuer/Card Program Manager 228 and the Transaction Request 208a will be forwarded to the Payment Server 210. The Card Issuer/Card Program Manager 228 requests approval of the Transaction Request 208a from the Payment Server 210.

The Payment Server 210 looks up to determine if the merchant is a registered or unregistered merchant and then generates a Payment Request 212 on behalf of the merchant. The generated Payment Request 212 is forwarded directly to the consumer's registered mobile computing device(s) (smart device 202) associated with the GlobalCard PAN for the customer to (i) verify that the Request has been provided by the merchant and (ii) validate that the transactional details have not been modified or changed. Verification and validation of the Payment Request follows the process shown and described with reference to FIG. 1 and FIG. 3.

The customer is required to select which eCard to use to make payment. The customer then selects an eCard and will be prompted to authorise the transaction. As the merchant is unregistered, a message will be provided to the customer via their registered smart device 202 advising that “as the merchant is un-registered, the customer will be taking a risk should the merchant prove to be fraudulent”. In effect, since the merchant has not registered with the Bluechain™ environment there is a risk that the merchant may not fulfil the order.

Assuming the customer authorises the transaction, a Payment Authorisation Message comprising a cryptogram is generated 214 and returned to the Payment Server 210 for verification and authorisation. The authorisation provided by the customer provides proof to Bluechain™ that the customer considers the transaction to be legitimate. The Payment Authorisation Message will be secured using the process described in WO2011/088508 and with reference to FIG. 3.

The Payment Server 210 will be able to verify the Payment Authorisation Message and look up the selected eCard to determine the financial account assigned to that eCard. The Payment Server 20 will then forward the Transaction Request 208b to the financial institution 232 managing the selected account for approval. The approval message 216 will be returned to the Payment Server 210 which will notify the Program Manager 228. The approval message 216 will then be provided back to the Card scheme switch 224, Acquirer 220 and merchant device 206 using traditional processes.

### Registered Entities/Merchants

A registered entity (the entity may be a merchant) is one that has been registered with the Bluechain™ environment. To compile a transaction request from the registered merchant, the customer will be required to enter their GlobalCard PAN, and customer detail into a Bluechain web plugin. Transactions performed with registered merchants will be pushed directly to the Payment Server 210 for processing. In other words, a Transaction Request 240 from a registered merchant flows direct from the merchant device 206 to the Payment Server 210. As for the case of the unregistered merchant, the Payment Server 210 determines if the merchant is a registered or unregistered merchant and then generates a Payment Request 212 on behalf of the merchant. The generated Payment Request 212 is forwarded directly to the smart device 202 or devices associated with the GlobalCard PAN to (i) verify that the Request has been provided by the merchant and (ii) validate that the transactional details have not been modified or changed. Verification and validation of the Payment Request follows the process shown and described with reference to FIG. 1 and FIG. 3.

The customer will be notified via their smart device 202 that the merchant is a registered user and that the transaction will be a guaranteed transaction. The customer will be prompted to select an eCard and to authorise the transaction. The consumer's smart device 202 will generate a Payment Authorisation Message as described with reference to FIG. 3. The Payment Authorisation Message is then sent to the Payment Server 210. The transaction authorisation will be secured using the WO11/088508 patent process and follows the process shown and described with reference to FIG. 3.

The Payment Server 210 will be able to verify the Payment Authorisation Message and forward the transaction to the financial institution 232 managing the selected account for approval. The approval message will be provided back to the scheme switch, Acquirer 220 and merchant 214 using traditional processes.

FIG. 3 is flowchart depicting the method of facilitating a secure transaction authentication in either the case of a registered or unregistered merchant.

The customer enters their GlobalCard PAN and contact detail on a payment webpage of a requesting entity (305). A Transaction Request is generated and is forwarded to the Payment Server for authorisation if the requesting entity is registered (310) and is forwarded to the Program Manager if the requesting entity is unregistered (315) which on forwards the Transaction Request to the Payment Server (320).

A Payment Request is compiled and the GlobalCard PAN is used to identify the mobile computing device(s) which is/are to receive the Payment Request (325). The Payment Request contains two pieces of information or data attributes (330), which can be sent as a single message (a single data packet) or as individual messages/data packets. The first data attribute comprises a requesting entity certificate signed with a private key of the card issuer or card program manager and the second data attribute comprises transaction data specifying the transaction, the transaction request having been signed with the private key of the card issuer or card program manager. The requesting entity certificate includes an identifier of the requesting entity and account details of the requesting entity. Program Server 210 forwards the Payment Request to the payment application on the identified mobile computing device (330). The first and second data attributes are passed to the mobile computing device's security module (335). The security module verifies the certificate from a public key known to or accessible to the device itself and the mobile computing device will use the public key from the requesting entity certificate to validate the transaction (340).

Once the certificate has been verified and the transaction validated, the customer will select an eCard indicative of the account from the which the transaction is to be drawn from (345). Once the customer has selected the eCard, the customer's mobile computing device will form a Payment Authorisation Message (350).

To form the Payment Authorisation Message, the mobile computing device will take the requesting entity identifier and account details from the requesting entity certificate, transaction data provided from the requesting entity (the transaction amount), the payment entity identifier and account details from the payment entity certificate, and mobile computing device data being the identifier of the application that was generated at the time of provisioning to the device. It should be appreciate that the account details from the payment entity certificate are details associated with the selected eCard. The mobile computing device will then create a cryptogram using a symmetric key which is stored on the mobile computing device and known by the relevant financial institution.

Preferably the Payment Authorisation Message will also include transaction including a unique counter value and one or more invoice line items. The transaction data may further optionally include one or more of the date of the transaction, the time of the transaction, and the invoice number.

In addition to data specified to form the Payment Authorisation Message, addition data may be optionally included. From the requesting entity certificate, additional data may include one or more of: the identity of the issuing entity, the name of the issuing entity and its image, such as a corporate logo. From the payment entity certificate, additional data may include the issuing entity name.

The mobile computing device will send the Payment Authorisation Message to the Payment Server which will forward the Payment Authorisation Message to the financial institution managing the selected account associated with the eCard for approval (355). The financial institution will validate the cryptogram against payment transaction data provided and the symmetric key associated with the selected account and mobile computing device. The financial institution will provide the Payment Server with an authorisation response (360). The Payment Server will inform the Program Manager of the response (365).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method is provided which comprises:
receiving at a server system associated with a card issuer or card program manager a transaction request for a transaction, the transaction request containing data to identify a customer account number;
determining a mobile computing device associated with the customer account number;
transmitting to the mobile computing device a payment request, the payment request comprising: (i) a requesting entity certificate signed with a private key of the card issuer or card program manager, and (ii) transaction data specifying the transaction and signed with the private key defined in (i); and
receiving from the mobile computing device a payment authorisation message to authorise the transaction, the payment authorisation message comprising a cryptogram based on (i) data contained in the requesting entity certificate, (ii) data contained in a payment entity certificate, (iii) transaction data and (iv) mobile computing device data, where the cryptogram is signed with a cryptographic key stored on the mobile computing device.

2. The method of claim 1, wherein the transaction request is received from a client computing device via a merchant server.

3. The method of claim 2, wherein the client computing device is different from the mobile computing device.

4. The method of claim 1, wherein transmitting a payment request to the mobile computing device comprises:
transmitting a first data packet comprising the requesting entity certificate signed with a private key of the card issuer or card program manager; and
separately transmitting a second data packet comprising the transaction data specifying the transaction and signed with the private key of the card issuer or card program manager.

5. The method of claim 1, wherein the cryptographic key is a symmetric key and the server system has access to a decryption key to decrypt the cryptogram and thereby determine whether the transaction has been authorised by the mobile computing device.

6. The method of claim 1, whereupon receiving the payment authorisation message to authorise the transaction, the method further comprises forwarding the transaction request to a financial institution managing a customer account associated with the customer account number.

7. The method of claim 1, further comprising generating a customer profile associated with the customer account number.

8. The method of claim 7, further comprising generating a plurality of virtual payment cards each of which is linked to the customer profile, wherein each virtual payment card is associated with a different customer account.

9. The method of claim 8, wherein each virtual payment card is linked to a unique mobile computing device.

10. The method of claim 9, wherein the data contained in the requesting entity certificate comprises at least a requesting entity identifier and account details from the requesting entity certificate, the data contained in the payment entity certificate comprises a payment entity identifier and account details from the payment entity certificate, and the transaction data comprises at least the transaction amount.

11. The method according to claim 10, wherein the account details from the payment entity certificate are associated with a selected virtual payment card, and wherein the selected virtual payment card is received from a user of the mobile computing device.

12. The method of claim 11, wherein the method further comprises forwarding the transaction request to a financial institution managing a customer account associated with the customer selected virtual payment card.

13. The method of claim 2, further comprising transmitting an authorisation notification to the merchant server in response to determining that the transaction request has been authorised.

14. A server system associated with a card issuer or card program manager, the server system comprising:
a memory;
a processor coupled to the memory and configured to:
receive a transaction request for a transaction, the transaction request containing data to identify a customer account number;
determine a mobile computing device associated with the customer account number;
transmit to the mobile computing device a payment request, the payment request comprising: (i) a requesting entity certificate signed with a private key of the card issuer or card program manager, and (ii) transaction data specifying the transaction and signed with the private key defined in (i); and
receive from the mobile computing device a payment authorisation message to authorise the transaction, the payment authorisation message comprising a cryptogram based on (i) data contained in the requesting entity certificate, (ii) data contained in a payment entity certificate, (iii) transaction data and (iv) mobile computing device data, the cryptogram signed with a cryptographic key stored on the mobile computing device.

15. The server system of claim 14, wherein the cryptographic key is a symmetric key and the server system has access to a decryption key to decrypt the cryptogram and thereby determine whether the transaction has been authorised by the mobile computing device.

16. The server system of claim 14, wherein the processor is further configured to generate a customer profile associated with the customer account number.

17. The server system of claim 16, wherein the processor is further configured to generate a plurality of virtual payment cards each of which is linked to the customer profile, wherein each virtual payment card is associated with a different customer account.

18. The server system of claim 17, wherein the data contained in the requesting entity certificate comprises at least a requesting entity identifier and account details from the requesting entity certificate, the data contained in the payment entity certificate comprises a payment entity identifier and account details from the payment entity certificate, and the transaction data comprises at least the transaction amount.

19. The server system of claim 18, wherein the account details from the payment entity certificate are associated with a selected virtual payment card, and wherein the processor is further configured to receive from a user of the mobile computing device data indicative of the selected virtual payment card.

20. The server system of claim 18, wherein the processor is further configured to forward the transaction request to a financial institution managing a customer account associated with the customer selected virtual payment card.

21. The server system of claim 14, wherein the processor is further configured to transmit an authorisation notification to the merchant server in response to determining that the transaction request has been authorised.

22. Computer-readable storage storing executable program instructions which, when executed by at least one computer processor, cause the at least one computer processor to perform the method of claim 1.
